(19) United States
(12) Patent Application Publication
(10) Pub. No.: US 2024/0280218 A1
(43) Pub. Date: Aug. 22, 2024

(54) VAPOR SHIELD

(71) Applicant: MVE Biological Solutions US, LLC, Brentwood, TN (US)

(72) Inventors: Justin Grunseth, Prior Lake, MN (US); Dale Mowrey, Montgomery, MN (US); Hanlin Feng, Carver, MN (US)

(73) Assignee: MVE Biological Solutions US, LLC, Brentwood, TN (US)

(21) Appl. No.: 18/112,975

(22) Filed: Feb. 22, 2023

(51) Int. Cl. F17C 3/08

(52) U.S. Cl. CPC F17C 3/08; F17C 2201/0119; F17C 2203/0391; F17C 2205/0165; F17C 2205/0311; F17C 2221/014; F17C 2223/0161; F17C 2227/0135

(57) ABSTRACT

A system, method and apparatus, and/or device is provided for a vapor shield. The vapor shield may attach to a cryogenic storage vessel having an opening and a pump out port. The vapor shield may include a collar, and a pump out port protector. The collar of the vapor shield may be attached to the opening of the cryogenic storage vessel and may support the pump out port protector. The pump out port protector may direct overflowing fluid, such as liquid cryogen, away from the pump out port. In this manner, the pump out port may be protected during filling and emptying of the cryogenic storage vessel with cooling fluid.

### BACKGROUND

### 1. Field

This specification relates to a system, device or apparatus to shield vapor and fluid spillage on a cryogenic storage vessel, such as a dewar.

### 2. Description of the Related Art

Cryogenic storage vessels, such as dewars, dry vapor shippers, or other vessels, are used to ship materials at very low temperatures. Cryogenic storage vessels may contain cooling agents to provide low temperatures to the contents of the cryogenic storage vessel. These cryogenic storage vessels may retain vaporized liquid nitrogen (or dry vapor) to produce a cryogenic temperature in the vessel. The cryogenic storage vessel may be vacuum insulated to maintain extreme cold temperatures.

The cryogenic storage vessel may be filled with cryogenic materials by pouring or placing liquids or other materials into the vessel. When materials are poured or placed in a cryogenic storage vessel, these materials may overflow or otherwise spill from or near the top of the storage vessel. This overflow or spillage may cause cooling and temperature gradients on a side of the cryogenic storage vessel. In some instances, a localized cooling or temperature gradient may degrade features of the vessel, such as sealing of a vacuum port or other aspects of the vessel. Thus, there is a need for a shield that protects features of the cryogenic storage vessel from cooling resultant from spillage and overflow.

### SUMMARY

In general, one aspect of the subject matter described in this specification is a vapor shield mechanism. The vapor shield system may include a cryogenic storage vessel having an opening. The vessel may have a pump out port. The vapor shield system may further include a vapor shield comprising a collar, and a pump out port protector. In various examples, the collar of the vapor shield is attached to the opening of the cryogenic storage vessel and defines an opening in the collar of the vapor shield. The opening may be in a center of the collar of the vapor shield.

These and other embodiment may optionally include one or more of the following features. The pump out port protector may be positioned adjacent to the pump out port to allow fluid overflow from the cryogenic storage vessel to re-route away from the pump out port. The vapor shield may be removable from the cryogenic storage vessel. The system may further include a notch configured to direct fluid. The pump out protector may be at least 30 degrees from the notch. The notch may be configured to allow fluid to overflow. The cryogenic storage vessel may further comprise a lid, the lid configured to fit into the opening of the cryogenic storage vessel. The cryogenic storage vessel may further comprise a payload sleeve, the payload sleeve configured to be inserted in the opening of the cryogenic storage vessel, the payload sleeve comprising a tab, the tab configured to fit into the notch of the vapor shield.

In another aspect, the subject matter may be a vapor shield device. The vapor shield device may comprise a collar configured to attach to an opening of a cryogenic storage vessel. The vapor shield device may comprise a pump out port protector connected to the collar, wherein the pump out port protector is positioned adjacent to a pump out port of a cryogenic storage vessel. The vapor shield device may comprise a notch in the collar, wherein the notch is configured to provide a channel for overflow of fluids from the cryogenic storage vessel.

In another aspect, a method is provided. The method may include placing a payload sleeve in an opening of a cryogenic storage vessel. The cryogenic storage vessel may have a pump out port and a vapor shield. The method may include pouring a fluid cooling agent in the opening of the cryogenic storage vessel. The method may include directing the fluid cooling agent around the pump out port by the vapor shield.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 shows an exploded view of an exemplary cryogenic storage vessel comprising a vapor shield, in accordance with various embodiments;

FIGS. 2A and 2B show perspective views of an exemplary vapor shield, in accordance with various embodiments;

FIG. 3A shows a top-down view of a vapor shield comprising a notch, in accordance with various embodiments;

FIG. 3B shows a top-down view of a vapor shield comprising a plurality of notches, in accordance with various embodiments;

FIG. 3C shows a top-down view of a vapor shield comprising fasteners, in accordance with various embodiments;

FIG. 3D shows a top-down view of a vapor shield comprising fasteners and a plurality of notches, according to an aspect of the invention;

FIG. 4A shows a vapor shield attaching to a dewar, in accordance with various embodiments;

FIG. 4B shows the bottom of a vapor shield, in accordance with various embodiments;

FIG. 5A shows the bottom of a vapor shield attachable by fasteners, in accordance with various embodiments;

FIG. 5B shows a cross section of a vapor shield attachable by fasteners, in accordance with various embodiments;

FIG. 5C shows an exploded view of a vapor shield attached to a dewar by fasteners, in accordance with various embodiments;

FIG. 6A shows a top view of a vapor shield attachable by clamping, in accordance with various embodiments;

FIG. 6B shows a bottom view of a vapor shield attachable by clamping, in accordance with various embodiments;

FIG. 6C shows a cross-section view of a vapor shield attachable by clamping, in accordance with various embodiments;

FIG. 6D shows another bottom view of a vapor shield attachable by clamping, in accordance with various embodiments;

FIG. 6E shows a vapor shield attachable by clamping and an associated fastener, in accordance with various embodiments;

FIGS. 6F-6G show perspective views of a vapor shield attachable by clamping and attached to a dewar, in accordance with various embodiments; and

FIG. 7 illustrates a method for using a vapor shield, in accordance with various embodiments.

### DETAILED DESCRIPTION

Disclosed herein are systems, devices and/or methods for shielding a feature of a cryogenic storage vessel such as a pump out port of the cryogenic storage vessel.

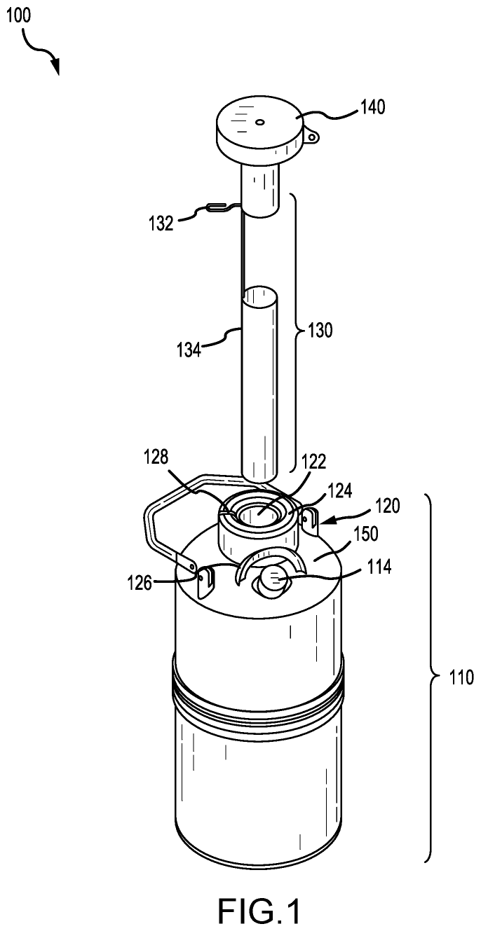

With reference to FIG. 1, a dewar 100 is illustrated in accordance with various embodiments. FIG. 1 shows an exemplary cryogenic storage vessel (or dewar 100). The dewar 100 may interchangeably be referred to as a cryogenic storage vessel or just vessel throughout. The dewar 100 may include a body 110, a payload sleeve 130 and a lid 140.

In various embodiments, the body 110 of the dewar 100 may define an opening 122. The opening 122 may be an aperture defined through a top of the dewar 100. The aperture may provide a passage for a payload sleeve 130 to be inserted into the dewar 100. The aperture may permit a cryogen to be filled into the body 110 of the dewar 100. The aperture may permit a payload to be placed into or taken out from the body 110 of the dewar 100. The cap 140 may be structured to correspond in shape with the opening 122 and provide an at least partial closure of the opening 122 when emplaced in and/or on the opening 122.

In various embodiments, the body 110 of the dewar 100 may comprise a pump out port 114. In various embodiments, the pump out port 114 may be an opening and/or valve in the dewar 100 to allow evacuation of gas or liquid from a space between an inner wall and an outer wall of the dewar. The pump out port 114 may be a valve, other pressure release port, or other configuration designed to selectively release gas flow. For example, the pump out port 114 may be used to evacuate one or more internal space, such as an area between the inner wall and the outer wall of the dewar 100 in order to enhance thermal insulation of a compartment inward of the inner wall. This internal space may be termed a “vacuum space.” In various embodiments, the pump out port 114 may be positioned in proximity to the opening 122 of the dewar 100. For example, the opening 122 may be on the top of the dewar 100 when the dewar 100 is positioned upright. Further, in various embodiments, the pump out port 114 may be positioned in proximity to the top of the dewar 100.

In various embodiments, the vacuum space of the dewar 100 is in fluid communication with the pump out port 114. The pump out port 114 may be used to release fluid, such as gas, from the vacuum space of the dewar 100. A pump may be attached to the pump out port 114 and activated to remove gas from the vacuum space, creating an insulative envelope between the inner and outer walls of the dewar.

The pump out port 114 may be positioned on an upper portion of the dewar 100. For instance, the pump out port 114 may be adjacent to a lid 140 that permits access to a storage compartment of the dewar. The lid 140 may be inserted into the top of the dewar 100 to close the storage compartment. The lid 140 may be removed to permit filling of the dewar with a payload and/or cryogen. During the filling process, cryogen, associated vapors and liquid may escape and cool the adjacent pump out port 114 causing potential degradation of the vacuum seal of the pump out port 114 and/or leakage of the vacuum space. As such, a vapor shield 120 discussed further herein may be provided to ameliorate cooling of the pump out port 114 by escaping vapors or cryogen.

In various embodiment, the dewar 100 may comprise a top portion 150. The top portion may be curved. The top portion may have multiple curves and/or compound curves. As such, the top portion 150 may be a conical top portion 150. The conical top portion 150 may be shaped as a vertical truncated cone. The conical top portion 150 may be a panel that is has a wider radius at the bottom and more narrow radius at the top. The pump out port 114 may be positioned on the side of the conical top portion 150. The pump out port 114 may be in proximity to the opening 122 of the dewar 100. Any vapor or cryogen escaping the dewar may escape an opening at or near an upper apex of the conical top portion 150. The upper apex may be a point on a surface of the conical top portion 150 having a tangent plane orthogonal to a vector aligned parallel with the insertion and removal path of the lid 140. Escaping vapor or cryogen may flow down the surface of the conical top portion 150, potentially contacting the pump out port 114. This potential contact is ameliorated by the vapor shield 120 discussed herein.

As mentioned, the body 110 of the dewar 100 may include a vapor shield 120. In various embodiments, the vapor shield 120 may be removably attached to the dewar 100. The vapor shield 120, in various embodiments, may comprise a pump out port protector 126. In various embodiments, the pump out port protector 126 may be a curved shield structure. In various embodiments, the pump out port protector 126 may be configured to ameliorate contact of spilling cryogen or associated vapors with the pump out port 114. For example, the pump out port protector 126 of the vapor shield 120 may be positioned adjacent to and/or above the pump out port 114 to allow fluid overflow from the cryogenic storage vessel to be directed away from the pump out port 114.

The pump out port protector 126 may be a hood structure above the pump out port 114 configured to direct the overflow of fluid from the dewar 100, away from the pump out port 114. The pump out port protector 126 may be configured to divert fluid to flow away from the pump out port 114. This embodiment provides the benefit of the fluid not contacting the pump out port 114 and potentially cooling or freezing the pump out port 114, which may be deleterious to the sealing of the port. In various embodiments, the vapor shield 120 may be attached and/or removed from the dewar 100. In various embodiments, the pump out port protector 126 may attached or removably attached directly to the dewar 100.

In various embodiments, the vapor shield 120 may comprise a collar 124. In various embodiments, the collar 124 may be an at least partially circularly-shaped structure attached to or formed unitarily with the pump out port protector 126.

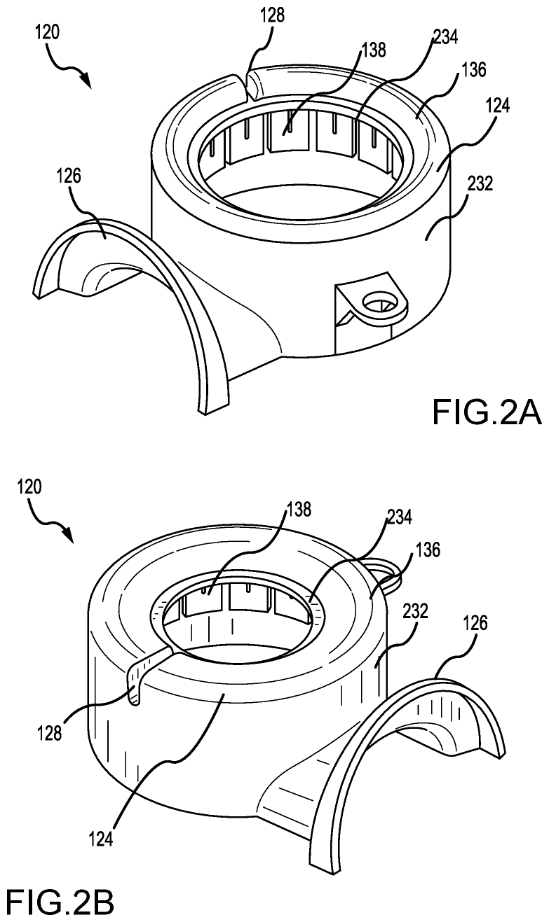

The collar 124 of the vapor shield 120 may removably attach to a neck of the dewar 100. In various embodiments, the collar 124 may comprise a hollow center. For example, and as described in further detail in regard to FIGS. 2A and 2B, the collar 124 may have a center which defines an opening in the vapor shield 120.

Continuing with reference to FIG. 1, in various embodiments, the collar 124 may be attached to the dewar 100 adjacent to the opening 122 of the dewar 100. The collar 124 may, in various embodiments, be removed from the dewar 100. In various embodiments, the vapor shield 120 and/or the collar 124 may comprise a plurality of holes or channels, the holes or channels including absorbent material. For example, the collar 124 and/or vapor shield 120 may comprise holes or channels including cork or other absorbent material to absorb fluid. Accordingly, as fluid is poured into the dewar 100, fluid may unintentionally be spilled on the vapor shield 120 and absorbed by the absorbent material.

In various embodiments, the vapor shield 120 may be attached to the body 110 of the dewar 100 using a material such as an epoxy, to allow the vapor shield 120 to be attached and removed if preferred. In various embodiments, the vapor shield 120 may be permanently attached to the dewar 100.

In various embodiments, a payload sleeve 130 may be inserted in the dewar 100. The payload sleeve 130 may be configured to be inserted into the opening 122 of the body 110 of the dewar 100. In various embodiments, the payload sleeve 130 may further comprise a tab 132 and a payload holder 134. The tab 132 may extend upward from the payload holder 134 to allow for a user to more easily insert and remove the payload holder 134 from the dewar 100.

In various embodiments, the vapor shield 120 may comprise a notch 128. In various embodiments the notch 128 may be on the collar 124 of the vapor shield 120. The notch 128 may be a channel or groove in the collar 124 of the vapor shield 120. The notch 128 may extend radially through the collar 124. In various embodiments, the notch 128 may be configured to direct overflowing fluid out of the dewar 100 and away from the pump out port 114. For example, as the dewar 100 is filled with fluid and the fluid may overflow, the overflow may flow out of the notch 128. In various embodiments, the notch 128 may be configured to receive the tab 132. For example, the tab 132 may be inserted into the notch 128 to prevent movement during shipment.

In various embodiments, the dewar 100 may further comprise a lid 140. For example, the lid 140 may be attached to the dewar 100 to close the body 110. In various embodiments, the lid 140 may be inserted into the opening 122 of the dewar 100.

With reference to FIGS. 2A and 2B, a vapor shield 120 is shown from various angles. In various embodiments, the pump out port protector 126 may be curved to direct fluid to fall on the sides. The pump out port protector 126 may be used as a shield to protect the pump out port 114. The vapor shield 120 may comprise adhesive or absorbent material on the inner portion of the collar 124.

In various embodiments, the collar 124 may comprise an exterior wall 232. In various embodiments, the exterior wall 232 may extend vertically. In various embodiment, the exterior wall 232 may partially extend vertically and comprise a lip and the bottom. For example, the lip at the bottom of the exterior wall 232 may protrude out of the vapor shield. The collar 124 may further comprise a circular top 136. The circular top 136 may be a circular panel that extends radially around a center point with a hollow center. The circular top may be connected at the outer radius to the exterior wall 232. The collar 124 may further comprise an inner collar portion 234. In various embodiments, the inner collar portion 234 defines an opening in the vapor shield 120.

In various embodiments, the vapor shield 120 may comprise attachment fixtures 138. The attachment fixtures 138 may be used to attach the vapor shield 120 to the body 110 of the dewar 100. In various embodiments, the attachment fixtures 138 may include one or more attachment tabs to secure the vapor shield 120 to the body 110 of the dewar 100. The tabs may pressure fit, or snap fit to the dewar 100 or may be affixed by epoxy, adhesive, glue or other material. In various embodiments, the attachment fixtures 138 may comprise channels to allow the attachment fixtures 138 to flex and securely attach to the body 110 of the dewar 100.

In various embodiments, the vapor shield 120 may comprise absorbent materials. For example, the vapor shield 120 may be a hollow structure with absorbent material inside. In various embodiments, the vapor shield 120 may comprise channels or grooves which include absorbent material. For example, as fluid is poured into the dewar 100, the vapor shield 120 may contain absorbent material configured to receive fluid and absorb fluid to prevent spillage. The absorbent material may be made of a sponge or other material capable of absorbing fluid such as a liquid or a vapor. In various embodiments, the absorbent material may be removed or replaced. Further, in various embodiments, the absorbent material may be configured to dry out between use.

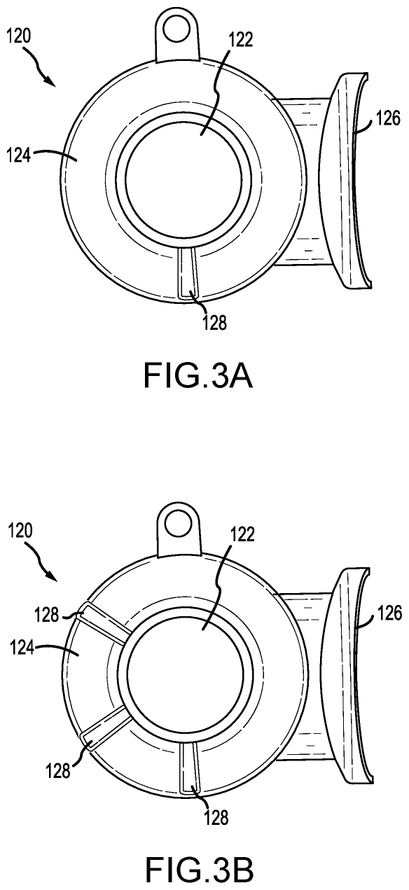

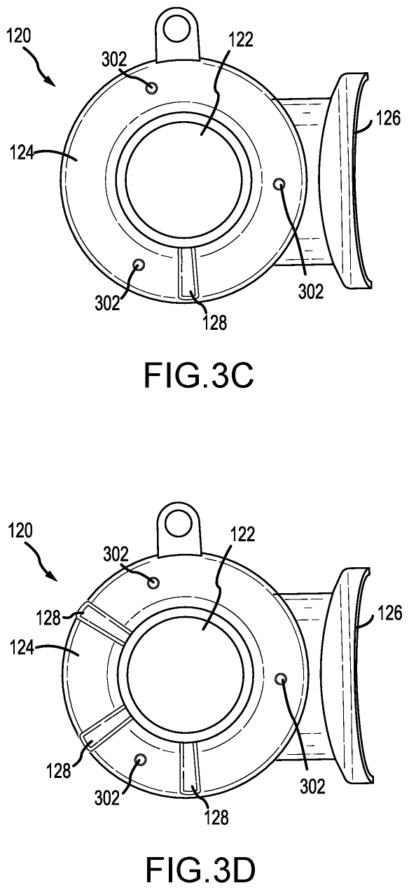

With reference now to FIGS. 3A-3D, top-down views of a vapor shield 120 are shown in accordance with various embodiments. The vapor shield 120 may comprise a collar 124. The vapor shield 120 may comprise one or more notches 128. The notch 128 may be positioned at least 30 degrees from the center of the pump out port protector 126. For example, the notch 128 may be positioned away from the pump out port protector 126 to direct fluid overflow away from the pump out port 114. In various embodiments, the notch 128 may be positioned less than or equal to 30 degrees from the center of the pump out port protector 126. For example, the notch 128 may direct the fluid overflow adjacent to the pump out port protector 126, and the pump out port protector 126 may divert the fluid away from the pump out port 144.

With reference to FIGS. 3B and 3D, in various embodiments, the vapor shield 120 may include two or more notches 128. For example, the collar 124 of the vapor shield 120 may include two or more notches 128. The two or more notches 128 may be spaced equally around the collar 124. In various embodiments, the two or more notches 128 may each be configured to direct fluid through the notches. For example, the two or more notches 128 direct the fluid to disperse the flow to the sides of the dewar and further prevent the fluid from touching the pump out port 144.

With reference to FIGS. 3C and 3D, in various embodiments, the vapor shield 120 may receive fasteners 302. The fasteners 302 may be used to attach the vapor shield 120 to the dewar 100. The fasteners 302 may be pins, screws, bolts, or other devices to connect the vapor shield 120 to the body 110 of the dewar 100. The vapor shield 120 may comprise one or more fasteners 302. In various embodiments, the fasteners 302 may be an opening configured to receive a pin, screw, bolt, or other device to connect the vapor shield 120 to the body 110 of the dewar 100. The body 110 of the dewar 100 may comprise slots or connection points for connecting to the fasteners 302 of the vapor shield 120.

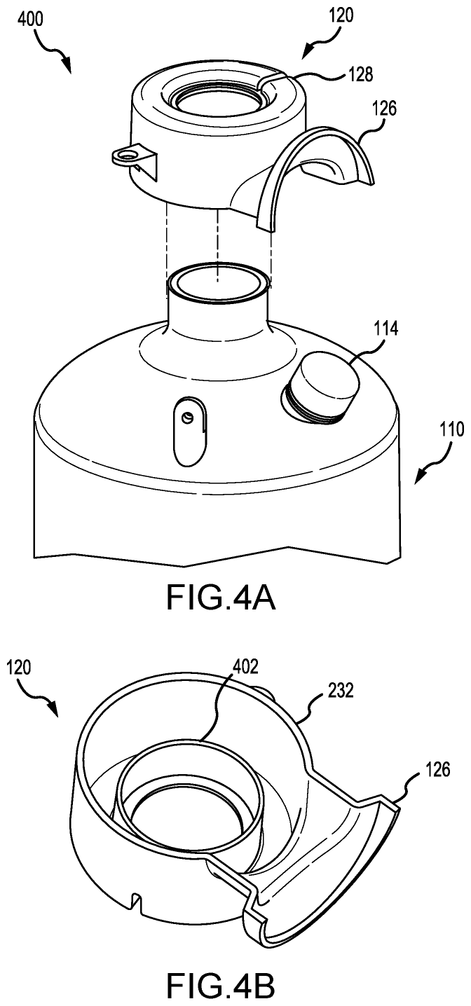

With reference to FIGS. 4A and 4B, a vapor shield 120 may attach to the dewar body 110. The vapor shield 120 may be attached by adhesives or other connective materials as described herein. The vapor shield 120 may be positioned so the pump out port protector 126 is proximally above the pump out port 114. With reference to FIG. 4B, the bottom of a vapor shield 120 is shown. The vapor shield 120 may be hollow. The vapor shield may have an interior wall 402. When the vapor shield 120 is attached to the dewar body 110, the interior wall 402 may extend into the neck of the dewar body 110. In further embodiments, the interior wall 402 extends annularly around the neck of the dewar body 110.

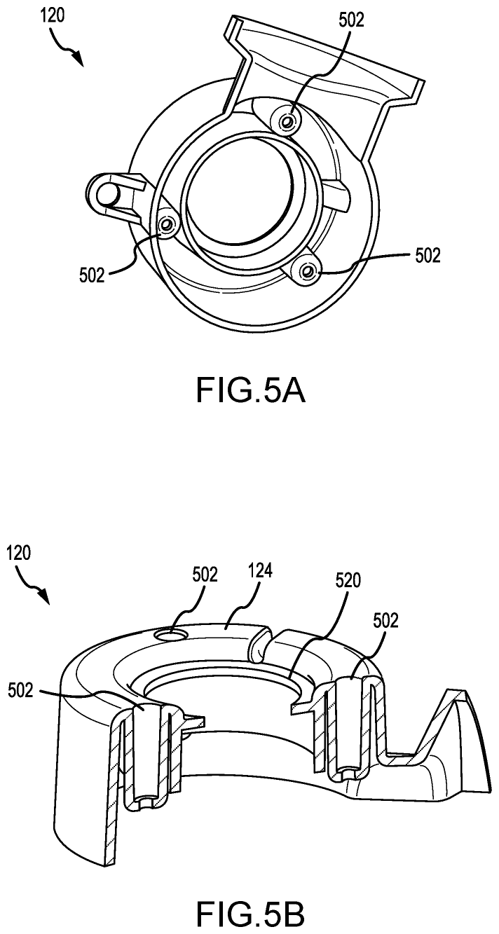

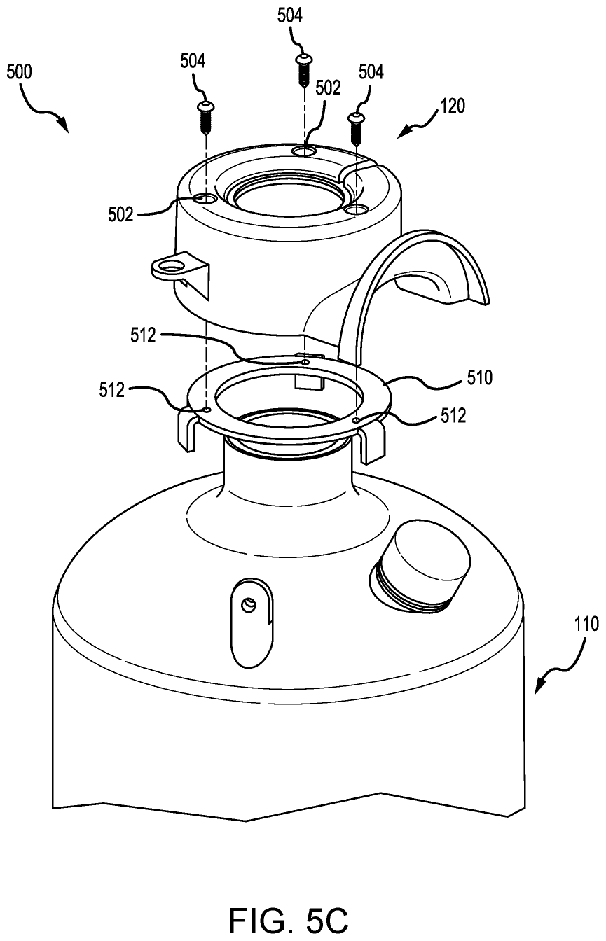

With reference to FIG. 5A-5C, the vapor shield 120 may comprise fasteners 502. The fasteners 502 may include channels extending in the collar 124 of the vapor shield 120. The vapor shield 120 may comprise one or more fasteners 502. The fasteners 502 may be positioned equidistant from each other on the collar 124. The fasteners 502 may configured to receive bolts, screws or other fixtures to attach the vapor shield 120 to the dewar body 110.

With reference to FIG. 5C, a fastener attachment system 500 is shown. In various embodiments, the vapor shield 120 may be attached to the dewar body 110 by a fastener attachment system 500. The fastener attachment system 500 may comprise one or more fasteners 502. The fasteners 502 may be similar to fasteners 302. The fastener attachment system 500 may comprise fastener bolts 504. The fastener bolts 504 may be configured to attach to the fasteners 502. For example, the fastener bolts 504 may be inserted into the fasteners 502. The fastener attachment system 500 may comprise a collar attachment plate 510. The collar attachment plate 510 may comprise receiving slots 512. The receiving slots 512 may be configured to receive fastener bolts 504. The collar attachment plate 510 may be attached to the neck of the dewar body 110.

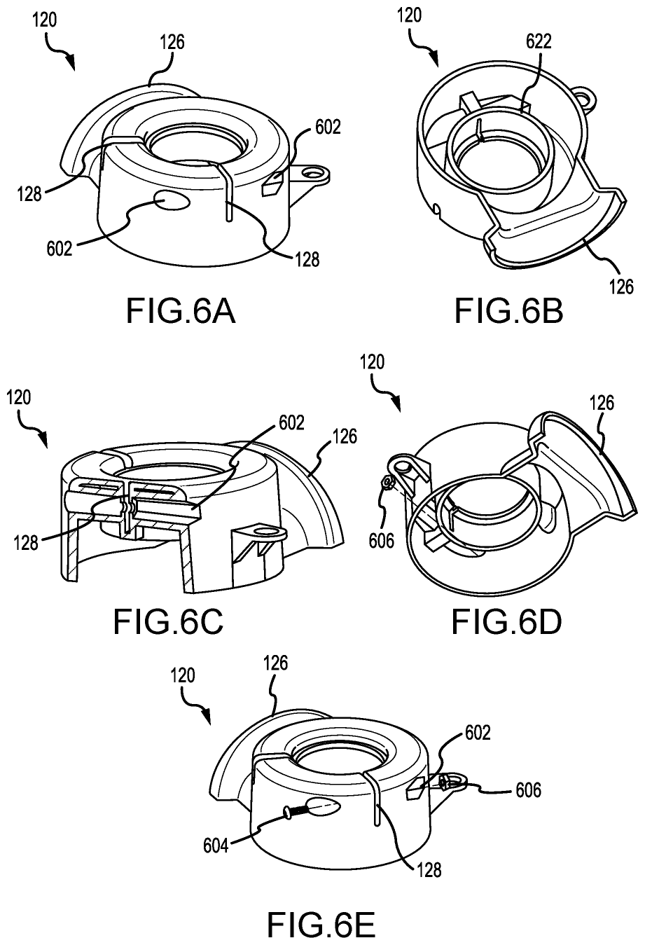

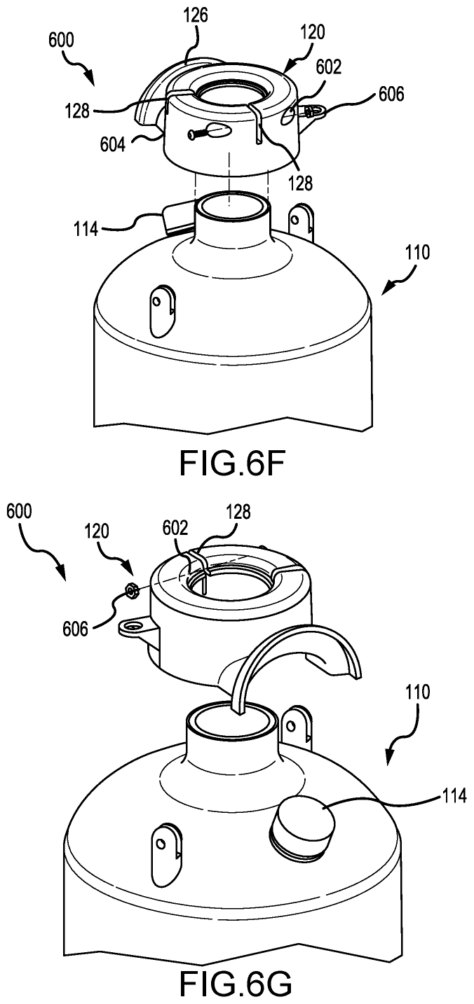

With reference to FIG. 6A-6G the vapor shield 120 may comprise a clamp fastener 602. The clamp fastener 602 may comprise a channel through the vapor shield 120. The channel may be a horizontal channel. The clamp may further comprise a notch 128 positioned in the channel of the clamp fastener 602, allowing for the clamp to be tightened. The vapor shield 120 may comprise an interior wall 622. The clamp fastener 602 may be positioned on opposite sides of the vapor shield 120 to the pump out port protector 126.

With reference to FIGS. 6F and 6G, and continued reference to FIGS. 6A-6E, a clamp attachment system 600 is shown. In various embodiments, the vapor shield 120 may be attached to the dewar body 110 by a clamp attachment system 600. The clamp attachment system 600 may comprise a clamp fastener 602. The clamp fastener 602 may comprise a bolt 604 and nut 606, wherein the bolt 604 and nut 606 may be used to tighten the vapor shield 120 to the neck of the dewar body 110. As the bolt 604 and nut 606 are tightened, the vapor shield 120 may compressively be clamped to the neck of the dewar body. The clamp fastener 602 may be used to attach the vapor shield 120 to the neck of the body 110 of the dewar 100.

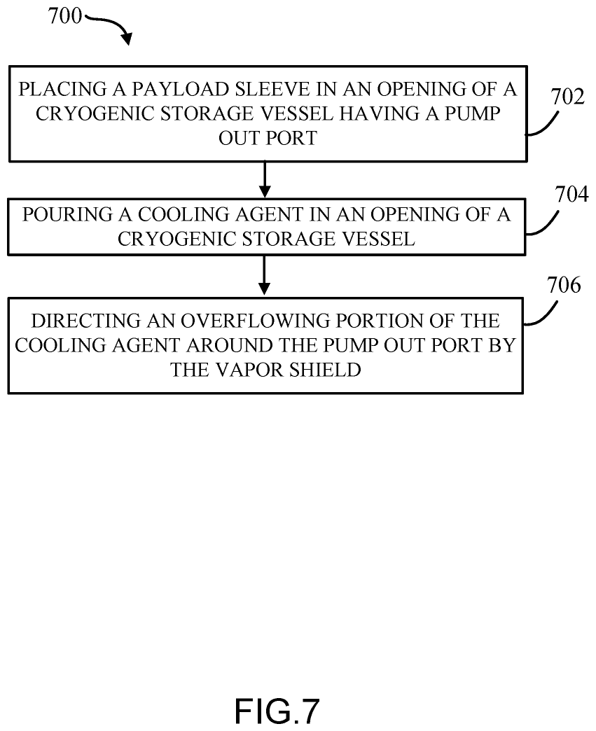

With reference now to FIG. 7, a method 700 for using a vapor shield is provided. In various embodiments, the method 700 may include placing a payload sleeve in an opening of a cryogenic storage vessel (block 702). The cryogenic storage vessel may be a dewar or insulated container. The cryogenic storage vessel may have a pump out port and a vapor shield. The method 700 may further include pouring a cooling agent in the opening of the cryogenic storage vessel (block 704). For example, a cooling agent may be a liquid cooling agent such as liquid nitrogen or other cooling liquid. This method 700 may further include directing an overflowing portion of the cooling agent around the pump out port by the vapor shield (block 706). In various embodiments, the vapor shield may comprise a pump out port protector positioned adjacent to the pump out port to allow fluid overflow from the cryogenic storage vessel to re-route away from the pump out port.

In various embodiment, the method 700 may further include removing the vapor shield from the cryogenic storage vessel. For example, the vapor shield may be removably attached to the cryogenic storage vessel. In various embodiments, the method 700 may further comprise attaching a lid to the opening of the cryogenic storage vessel. For example, the lid may be inserted into the opening of the dewar to seal or partially seal the cryogenic storage vessel.

While the preferred embodiments of the disclosure have been shown and described, it will be apparent to those skilled in the art that changes and modifications may be made therein without departing from the spirit of the disclosure, the scope of which is defined by the following claims.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure.

The scope of the disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. All ranges and ratio limits disclosed herein may be combined.

Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

Any reference to attached, fixed, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts or areas but not necessarily to denote the same or different materials. In some cases, reference coordinates may be specific to each figure.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

What is claimed is:

1. A vapor shield system comprising:
a cryogenic storage vessel having an opening and a pump out port; and
a vapor shield comprising a collar, and a pump out port protector;
wherein the collar of the vapor shield is attached to an opening of the cryogenic storage vessel and defines an aperture in the collar of the vapor shield.

2. The system of claim 1, wherein the pump out port protector is positioned adjacent to the pump out port to allow fluid overflow from the cryogenic storage vessel to direct fluid away from the pump out port.

3. The system of claim 1, wherein the vapor shield is removable from the cryogenic storage vessel.

4. The system of claim 1, further comprising a notch configured to direct fluid overflow.

5. The system of claim 4, wherein the pump out protector is at least 30 degrees from the notch.

6. The system of claim 1, wherein the cryogenic storage vessel further comprises a lid, the lid configured to fit into the opening of the cryogenic storage vessel.

7. The system of claim 4, further comprising a payload sleeve, the payload sleeve configured to be inserted in the opening of the cryogenic storage vessel, the payload sleeve comprising a tab, the tab configured to fit into the notch of the vapor shield.

8. A vapor shield device comprising:
a collar configured to attach to an opening of a cryogenic storage vessel; and
a pump out port protector connected to the collar, wherein the pump out port protector is positioned adjacent to a pump out port of the cryogenic storage vessel.

9. The device of claim 8, further comprising a notch in the collar, wherein the notch is configured to provide a channel to direct overflow of fluids from the cryogenic storage vessel.

10. The device of claim 8, wherein the pump out port protector is configured to allow fluid overflow from the cryogenic storage vessel to re-route away from the pump out port.

11. The device of claim 8, wherein the vapor shield device is removably attached to the cryogenic storage vessel.

12. The device of claim 9, wherein the pump out protector is at least 30 degrees from the notch.

13. The device of claim 9, further comprising a payload sleeve, the payload sleeve configured to be inserted in the opening of the cryogenic storage vessel, the payload sleeve comprising a tab, the tab configured to fit into the notch of the vapor shield device.

14. A method of using a vapor shield comprising:
placing a payload sleeve in an opening of a cryogenic storage vessel, the cryogenic storage vessel having a pump out port and a vapor shield;
pouring a cooling agent in the opening of the cryogenic storage vessel; and
directing an overflowing portion of the cooling agent around the pump out port by the vapor shield.

15. The method of claim 14, wherein the vapor shield comprises a pump out port protector which is positioned above the pump out port to direct fluid away from the pump out port.

16. The method of claim 14, further comprising:
removing the vapor shield from the cryogenic storage vessel.

17. The method of claim 15, further comprising a notch configured to direct overflow of fluid, wherein the notch is at least 30 degrees from center of the pump out port protector.

18. The method of claim 14, further comprising:
attaching a lid to the opening of the cryogenic storage vessel.

19. The method of claim 17, wherein the payload sleeve comprises a tab, the tab configured to fit into the notch of the vapor shield.

20. The method of claim 17, further comprising:
inserting a tab of the payload sleeve into the notch of the vapor shield.

21. A storage vessel vapor shield system comprising:
a cryogenic storage vessel comprising a pump out port;
a vapor shield comprising a pump out port protector;
wherein the pump out port protector is configured to attach the cryogenic storage vessel such that the pump out port protector positioned above the pump out port when the cryogenic storage vessel is in an upright position;
wherein the pump out port protector is configured to direct fluid overflow away from the pump out port.

22. The system of claim 21, wherein the pump out port protector is removable from the cryogenic storage vessel.

23. The system of claim 21, wherein the vapor shield comprises a notch, the notch configured to direct fluid overflow from the cryogenic storage vessel.

24. The system of claim 21, wherein the pump out port protector is a hooded ramp structure configured to partially overlay the pump out port.

25. The system of claim 21, wherein the vapor shield is attached to the cryogenic storage vessel by a clamp, the clamp configured to tighten the vapor shield onto the cryogenic storage vessel.

26. The system of claim 21, wherein the vapor shield is attached to the cryogenic storage vessel by one or more fasteners.
